(19) United States
(12) Patent Application Publication
(10) Pub. No.: US 2013/0101403 A1
(43) Pub. Date: Apr. 25, 2013

(54) AERODYNAMIC MODIFICATION OF A RING FOIL FOR A FLUID TURBINE

(71) Applicant: FloDesign Wind Turbine Corp., Waltham, MA (US)

(72) Inventors: Walter M. Presz, JR., Wilbraham, MA (US); Michael J. Werle, West Hartford, CT (US); Ercan Dumlupinar, Palmer, MA (US)

(73) Assignee: FLODESIGN WIND TURBINE CORP., Waltham, MA (US)

(21) Appl. No.: 13/657,768

(22) Filed: Oct. 22, 2012

Related U.S. Application Data
(60) Provisional application No. 61/549,465, filed on Oct. 20, 2011.

(51) Int. Cl. F03D 11/00

(52) U.S. Cl. 415/182.1

(57) ABSTRACT

A ring fluid foil including a modified trailing portion for a shrouded fluid turbine and shrouded fluid turbine including such ring fluid foils are described herein. The modification of the trailing portion increases flow turning by the fluid foil without, or with reduced, boundary layer separation on a suction side of the fluid foil.

### CROSS-REFERENCE TO RELATED APPLICATION

This application claims priority to and benefit of U.S. Provisional Patent Application No. 61/549,465, filed Oct. 20, 2011, the contents of which are incorporated herein by reference in their entirety.

### TECHNICAL FIELD

The present embodiment relates to the field of fluid turbines and more particularly to ringed airfoils for shrouded turbines.

### BACKGROUND

Utility scale wind turbines used for power generation have a rotor that usually includes one to five open blades. The rotor of each wind turbine transforms wind energy into a rotational torque that drives at least one generator that is rotationally coupled to the rotor either directly or through a transmission to convert mechanical energy to electrical energy. Some wind turbines include one or more shrouds in the form of ring airfoils that can increase efficiency of the wind turbine by drawing more air through the wind turbine, for example, a multi-shroud wind turbine is described in U.S. Pat. No. 8,021,100.

### SUMMARY

Example embodiments described herein include, but are not limited to ring fluid foils for shrouded fluid turbines, and shrouded fluid turbines including one or more ring fluid foils. An embodiment includes an aerodynamically contoured ring fluid foil for use in an energy extraction fluid turbine. The ring fluid foil includes a suction surface facing toward a central longitudinal axis of the ring fluid foil and a pressure surface opposite the suction surface. The ring fluid foil also includes a bluff protrusion at a trailing portion of the ring fluid foil that extends outwardly from the pressure surface and away from a chord of a non-protrusion portion of the ring fluid foil.

In some embodiments, a side cross-section of the ring fluid foil has a longitudinal axis of the bluff protrusion oriented at an angle of between 85 degrees and 120 degrees with respect to the chord of the non-protrusion portion of the ring fluid foil. In some embodiments, a side cross-section of the ring fluid foil has a longitudinal axis of the bluff protrusion oriented about perpendicular to the chord of the non-protrusion portion of the ring fluid foil.

In some embodiments, a height of the bluff protrusion is between 0.5% and 30% of a length of the chord. In some embodiments, the height of the bluff protrusion is between 1% and 10% of the length of the chord.

In some embodiments, the bluff protrusion has a shape configured to generate a counter-rotating pair of fluid vortices downstream of and proximal to the bluff protrusion. In some embodiments, the counter-rotating pair of fluid vortices generated downstream of and proximal to the bluff protrusion deflect a flow stream from the suction surface away from the central axis. In some embodiments, the counter-rotating pair of fluid vortices is generated downstream of and proximal to the bluff protrusion without boundary layer flow separation on the suction surface.

In some embodiments, the bluff protrusion defines channels extending from a leading surface of the bluff protrusion to a trailing surface of the bluff protrusion. In some embodiments, the channels include slots at least partially separating the bluff protrusion and the non-protrusion portion of the ring fluid foil.

An embodiment includes an energy extraction fluid turbine, which has a rotor configured to rotate about a central longitudinal axis, and a ring fluid foil having a trailing edge downstream of the rotor. The ring fluid foil includes a suction surface facing toward the central axis, and a pressure surface opposite the suction surface. The and a bluff protrusion at a trailing portion of the ring fluid foil that extends outwardly from the pressure surface and away from a chord of a non-protrusion portion of the ring fluid foil.

Another embodiment includes a contoured ring fluid foil for use in an energy extraction fluid turbine. The ring fluid foil includes a suction surface facing toward a central axis of the ring fluid foil and a pressure surface opposite the suction surface. The pressure surface and the suction surface are joined by a blunt surface at a trailing portion of the ring fluid foil. The ring fluid foil has a cross-sectional profile with a mean camber line having a greater curvature in the trailing portion than in a leading portion of the ring fluid foil.

In some embodiments, the blunt surface and the profile are configured to create counter-rotating vortices downstream of and proximal to the trailing portion that deflect a flow stream from the suction surface away from the central axis. In some embodiments, the flow stream from the suction surface is deflected away from the central axis without boundary layer separation on the suction surface. In some embodiments,

In some embodiments, the curvature of mean camber line in the trailing portion is between 1.5 times and 2.5 times the curvature of the mean camber line in the leading portion.

Another embodiment includes an energy extraction fluid turbine having a rotor configured to rotate about a central axis and a ring fluid foil with a trailing edge downstream of the rotor. The ring fluid foil includes a suction surface facing toward the central axis and a pressure surface opposite the suction surface. The pressure surface and the suction surface are joined by a blunt surface at a trailing portion of the ring fluid foil. The ring fluid foil has a cross-sectional profile with a mean camber line having a greater curvature in the trailing portion than in a leading portion of the ring fluid foil.

In some embodiments, the ring fluid foil is an ejector shroud and the fluid turbine further includes a mixer shroud upstream of the ejector shroud. In some embodiments, the ring fluid foil is a mixer shroud and the fluid turbine further includes an ejector shroud downstream of the mixer shroud.

The summary above is provided merely to introduce a selection of concepts that are further described below in the detailed description. The summary is not intended to identify key or essential features of the claimed subject matter, nor is it intended to be used as an aid in limiting the scope of the claimed subject matter.

### BRIEF DESCRIPTION OF THE DRAWINGS

A more complete understanding of the components, processes, and apparatuses disclosed herein may be obtained by reference to the accompanying figures. These figures are intended to illustrate embodiments and are not intended to show relative sizes and dimensions, or to limit the scope of examples or embodiments. In the drawings, the same numbers are used throughout the drawings to reference like features and components of like function.

FIG. 1 is a front perspective view of a shrouded wind turbine, in accordance with an embodiment.

FIG. 2 is a side cross-sectional view of the shrouded wind turbine of FIG. 1.

FIG. 3 schematically depicts a side cross section of an upper portion of a conventional ring foil.

FIG. 4 schematically depicts the flow field around the conventional ring foil of FIG. 3 showing flow separation on the suction side near the trailing edge.

FIG. 5 schematically depicts a side cross section of an upper portion of a ring foil including a protrusion on a pressure surface extending away from a central axis, in accordance with an embodiment.

FIG. 6 schematically depicts the flow field around the ring foil of FIG. 5 showing a pair of counter-rotating vortices downstream of the protrusion and showing no flow separation on the suction side.

FIG. 7 schematically depicts a side cross section of an upper portion of a ring foil with an aerodynamically modified region trailing portion, in accordance with an embodiment.

FIG. 8 schematically depicts the flow field around the ring foil of FIG. 7.

FIG. 9 schematically depicts a side cross section of an upper portion of a ring foil with a highly modified trailing portion, in accordance with an embodiment.

FIG. 10 schematically depicts a side cross section of an upper portion of a ring foil including a suction surface with a protrusion having a channel, in accordance with an embodiment.

FIG. 11 schematically depicts a perspective view of a mixer-ejector fluid turbine with an ejector in the form of the ring foil of FIG. 10, in accordance with an embodiment.

FIG. 12 schematically depicts a perspective view of a single mixer shroud fluid turbine with outward mixer lobes including a trailing portion modified to have increased camber, in accordance with an embodiment.

FIG. 13 schematically depicts a side cross-sectional view of the mixer shroud fluid turbine of FIG. 12.

FIG. 14 schematically depicts a perspective view of a single mixer shroud fluid turbine with outward mixer lobes, each including a protrusion of a pressure surface in accordance with an embodiment.

FIG. 15 schematically depicts a side cross-sectional view of the fluid turbine of FIG. 14.

### DETAILED DESCRIPTION

Embodiments relate to a fluid turbine shroud (e.g., a wind turbine shroud, a water turbine shroud, a hydro turbine shroud) including a ring fluid foil (e.g., a ring airfoil, a ring hydrofoil) having a modified trailing edge portion that increases flow through the ring fluid foil by increasing fluid dynamic circulation without causing flow separation on a suction side of the foil, and a fluid turbine including such a shroud. A ring fluid foil, which may also be referred to as a ringed fluid foil or a ring foil, is a structure that at least partially encircles a central axis, and that, when split by a plane that includes the central axis, has an upper cross-sectional fluid foil profile and a lower cross-sectional fluid foil profile. Exemplary embodiments include fluid turbine shrouds, shrouded fluid turbines having a single shroud, and shrouded fluid turbines including multiple shrouds. In some embodiments, a bluff protrusion on a pressure surface of the ring foil increases flow turning and fluid dynamic circulation of the ring foil. As used herein, the term “bluff” refers to a non-streamlined shape that necessarily creates a region of non-laminar flow aft of the shape. In some embodiments, a bluff trailing portion of the foil, in the form of a blunt trailing surface and an increased curvature camber line in the trailing portion of the ring foil, increases flow turning and fluid dynamic circulation of the ring foil. As used herein, a “blunt trailing surface” or a “blunt trailing edge” refers to a distinct surface that separates the pressure surface of the foil from the suction surface of the foil at a trailing portion of the ring foil.

Although several embodiments described herein refer to wind, wind turbines and airfoils, the concepts are equally applicable to other types of fluid foils for other types of fluid turbines, such as water turbines or hydro turbines with ring hydrofoils. Accordingly, one of ordinary skill in the art in view of the present disclosure will appreciate that in each of the examples described herein the terms fluid, water or hydro could be substituted for air or wind and the terms foil or hydrofoil could be substituted for airfoil and vice versa.

In a shrouded fluid turbine, one or more shrouds are used to increase flow through a fluid turbine. A shroud includes a ring foil (e.g., an airfoil or a hydrofoil) with a suction side (e.g., a higher velocity side) facing a central rotational axis of the fluid turbine and a pressure side (e.g., a lower velocity side) facing away from the central axis. By turning the fluid flow downstream of the ring foil away from the central axis, the ring foil draws additional fluid past the turbine rotor, increasing power extraction by the fluid turbine. To further increase the turning of the fluid flow downstream of the foil and further increase the draw of fluid turbine flowing through the fluid turbine, an angle of attack of the foil may be increased and/or a camber of the foil may be increased. Unfortunately, substantially increasing the angle of attack of the foil and/or substantially increasing the camber of the foil can lead to stall. In the field of fluid dynamics, the term “stall” refers to the condition in which flow separation occurs. In flow separation, fluid flowing closely around the foil surface (i.e., the boundary layer flow) starts to detach from the surface and become turbulent (e.g., develops eddies and vortices), which often increases drag and decreases flow turning downstream of the foil. Some embodiments include a ring foil having a modified profile in a trailing portion for increased fluid turning down stream of the foil without boundary separation on a suction side of the ring foil.

Fluid flowing past a foil produces aerodynamic or hydrodynamic forces on both the foil and the fluid. The component of aerodynamic or hydrodynamic force on the foil that is perpendicular to the direction of fluid flow is called lift and the component of aerodynamic or hydrodynamic force on the foil that is parallel to the direction of fluid flow is called drag. A foil has a suction side and a pressure side. For many foils, the pressure surface and the suction surface are joined by a curved leading edge and a sharp trailing edge, meaning that the pressure side and the suction side meet at the trailing edge and are not separated by an additional surface at the trailing edge. A camber line of the foil dissects the trailing edge at one end and extends to the apex of the leading edge. Deflection of fluid flowing past the foil may be described as the fluid flow turning and following a curved path due to the presence of the foil. Aerodynamic or hydrodynamic circulation is a result of flow turning and is usually limited by flow separation on the foil suction side.

The Kutta-Joukowski theorem describes the circulation of a fluid around any closed surface. It is this circulation that causes lift on an airfoil and increases the fluid flow through a shrouded fluid turbine. The theorem determines the lift generated by one unit of span in a closed body and states that when the circulation Γ_{∞} is known, the lift per unit span (or L′) of the cylinder can be calculated using the following equation:

L′=ρ_{∞}V_{∞}Γ_{∞} Equation 1

Where ρ_{∞} and V_{∞} are the fluid density and the fluid velocity far upstream of the cylinder, and Γ_{∞} is the circulation defined as the line integral in equation 2:

Γ_{∞}= [symbol] _{C}_{_{∞}}V cos θ ds Equation 2

In flow around a foil, there are two stagnation points. The Kutta condition specifies the rear stagnation point occurs on the trailing edge of the foil. Maintaining the Kutta condition (as a function of the Kutta-Joukowski theorem) on the fluid-dynamic surfaces controls circulation generated by the foil, preventing flow separation from the surfaces until the flow reaches the trailing edge.

Embodiments increase fluid foil circulation through more effective flow turning, by modifying the fluid flow across the pressure side of the fluid foil in a trailing portion of the ring foil. This increased circulation may be accomplished by an increase in surface turning on the pressure side of the foil. Increased surface turning on the pressure side, which turns the pressure side surface into the oncoming flow, is less likely to cause flow separation than increased turning on the suction side away from the flow.

Some embodiments including a ring foil with protrusion on the pressure surface in the trailing portion of the airfoil that provides increased circulation by increasing turning downstream of the suction side. In some embodiments, the protrusion may be a flat plate or other protrusion on the foil pressure side that extends away from a chord of the non-protrusion portion of the foil. In some embodiments, a height of the protrusion may be about 1-30% of the chord in length. As noted above, the protrusion extends away from the chord of the non-protrusion part of the ring foil. For example, in some embodiments, the protrusion may be oriented about perpendicular to the chord line of the non-protrusion portion of the foil. In some embodiments, the trailing edge protrusion may be oriented at an angle of between 85 degrees and 120 degrees with respect to the chord line of the non-protrusion portion of the foil.

The protrusion effectively changes the flow-field downstream of the trailing edge of the ring foil by introducing a pair of counter-rotating vortices aft of and proximal to the protrusion, which alters the Kutta condition and circulation in the region. However, the abrupt transition in the shape of the pressure surface at the upstream side of the protrusion may significantly increase the drag on the foil. In some exemplary embodiments, the trailing portion of a ring foil is aerodynamically modified to increase fluid turning by the pressure surface of the foil without an abrupt transition, thus providing the increased circulation without the increased drag effect.

Some embodiments are described below with respect to single shroud fluid turbines. Some embodiments are described below with multiple shroud fluid turbines. Some embodiments are described below with respect to mixer-ejector multi-shroud turbines. One skilled in the art in view of the present disclosure will recognize that teachings herein may be readily applied to any number of ducted or shrouded fluid turbine applications. The recitation or illustration of any type of shrouded turbine (e.g., a mixer-ejector turbine (MET)) in an embodiment is not intended to be limiting in scope as is solely for convenience in illustrating the current invention.

As noted above, an exemplary ring foil may be employed in a MET. An MET provides an improved means of generating power from fluid currents. An MET includes tandem cambered shrouds that function as a mixer/ejector pump. Each of the cambered shrouds is a substantially ringed foil. A primary shroud, which may be referred to as a turbine shroud or a mixer shroud, houses a rotor that extracts power from a primary fluid stream. The secondary shroud downstream of the primary shroud, which may be referred to as an ejector shroud, collects an energized secondary bypass fluid stream that is mixed with the primary fluid stream downstream of the rotor to energize the output fluid stream. The mixer shroud and/or the ejector shroud may have a structure to promote rapid mixing of the primary and secondary fluid stream downstream of the rotor. For example, the mixer shroud may include mixing elements at the trailing edge of the ring foil that are in fluid communication with the ejector shroud. Energizing the output fluid stream accelerates the draw of fluid through the primary shroud past the rotor, resulting in more energy extraction due to higher flow rates. The mixer/ejector pump transfers energy from the bypass flow to the rotor wake flow allowing higher energy per unit mass flow rate through the rotor. The primary and secondary shrouds generate aerodynamic circulation resulting in suction on the inside of the turbine shroud and are part of a tightly coupled system that, combined with the mixer-ejector pump, allow the acceleration of more air through the turbine rotor as compared to un-shrouded designs, thus increasing the amount of power that may be extracted by the rotor. These two effects enhance the overall power production of the turbine system.

The term “rotor” is used herein to refer to any component or assembly in which one or more blades are attached to, or coupled with, a shaft and able to rotate, allowing for the extraction of energy or power from a fluid stream flow that rotates the blade(s). Example rotors include, but are not limited to, a propeller-like rotor, an impeller and a rotor/stator assembly. As understood by one skilled in the art, any type of rotor may be used in conjunction with the turbine shroud in a shrouded fluid turbine of the present disclosure.

A first component of the fluid turbine located closer to the front of the turbine may be considered “upstream” of a second component located closer to the rear of the turbine. For example, in an MET, the leading edge of a turbine shroud may be considered the front of the fluid turbine, and the trailing edge of an ejector shroud may be considered the rear of the fluid turbine. The ejector shroud would be downstream of the turbine shroud.

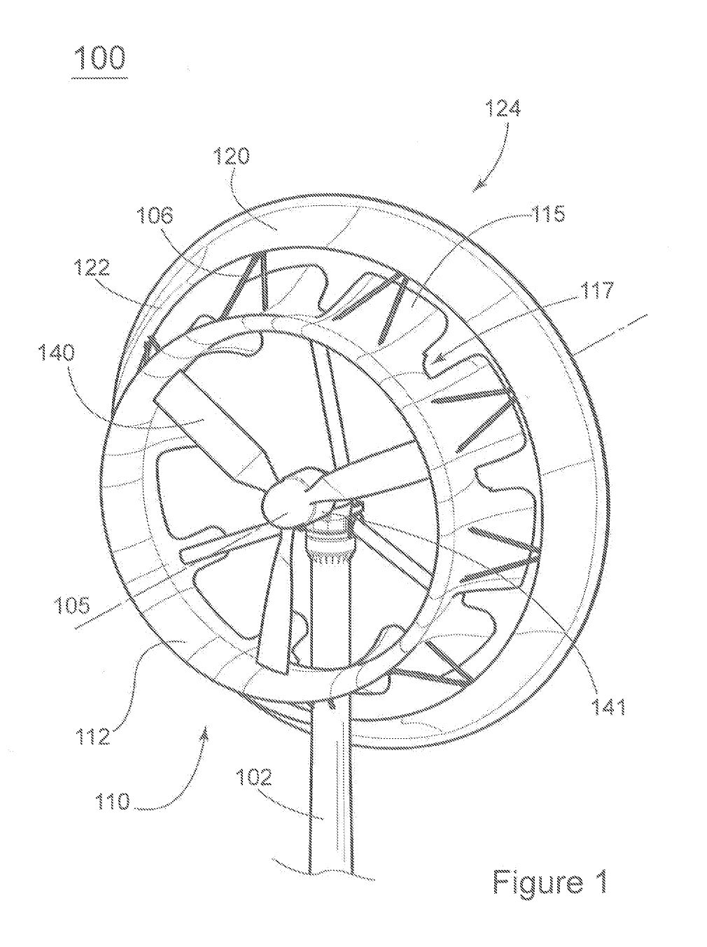

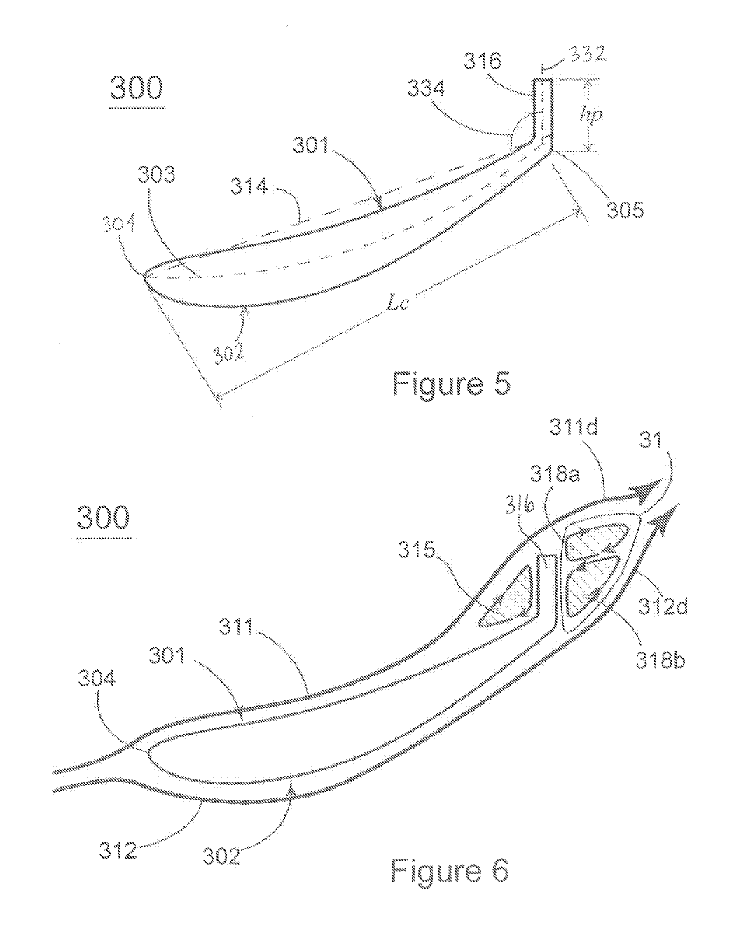

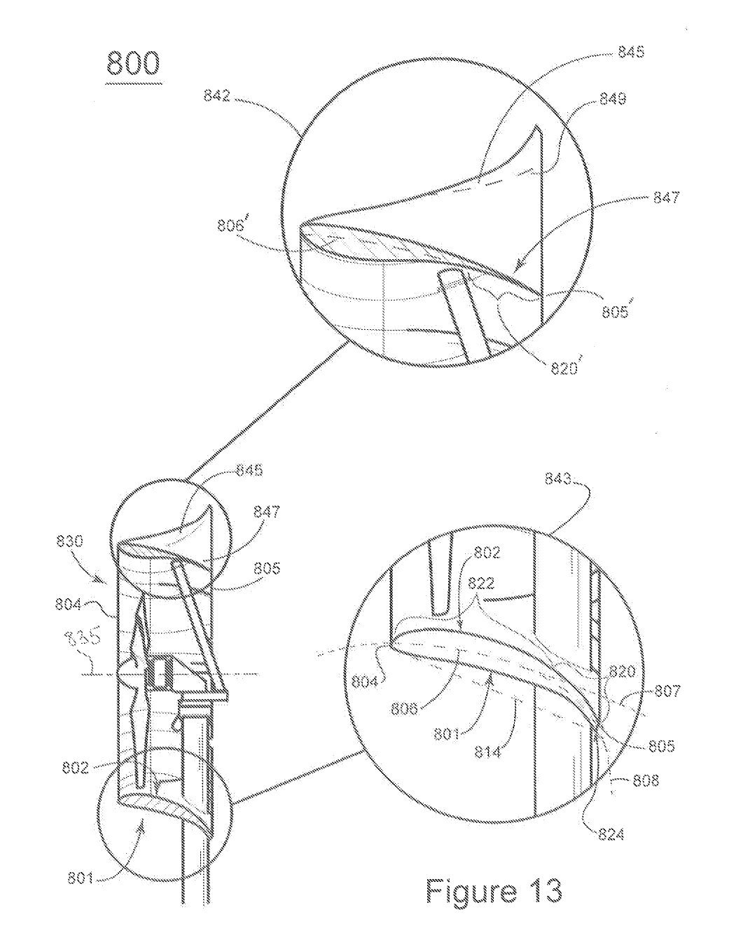

The modifications of ring fluid foils (hereafter ring foils) for greater flow turning described and taught herein are equally applicable to shrouded turbines having a single shroud and shrouded turbines having multiple shrouds. FIGS. 5-10 are used to describe modifications to a ring fluid foil for both shrouded turbines having a single shroud, and for shrouded turbines having more than one shroud. FIGS. 5-10 should not be construed as limiting embodiments to ring foils for fluid turbines having one shroud, ring foils for fluid turbines having two shrouds, or to fluid turbine having more than two shrouds. FIGS. 1, 2 and 11 should not be construed as limiting embodiments to ring fluid foils for dual shroud mixer-ejector fluid turbines. FIGS. 13-15 should not be construed as limiting embodiments to ring fluid foils for single shroud fluid turbines. Further, in multi-shroud embodiments, the fluid turning features may be incorporated in an upstream shroud, in a downstream shroud or in both.

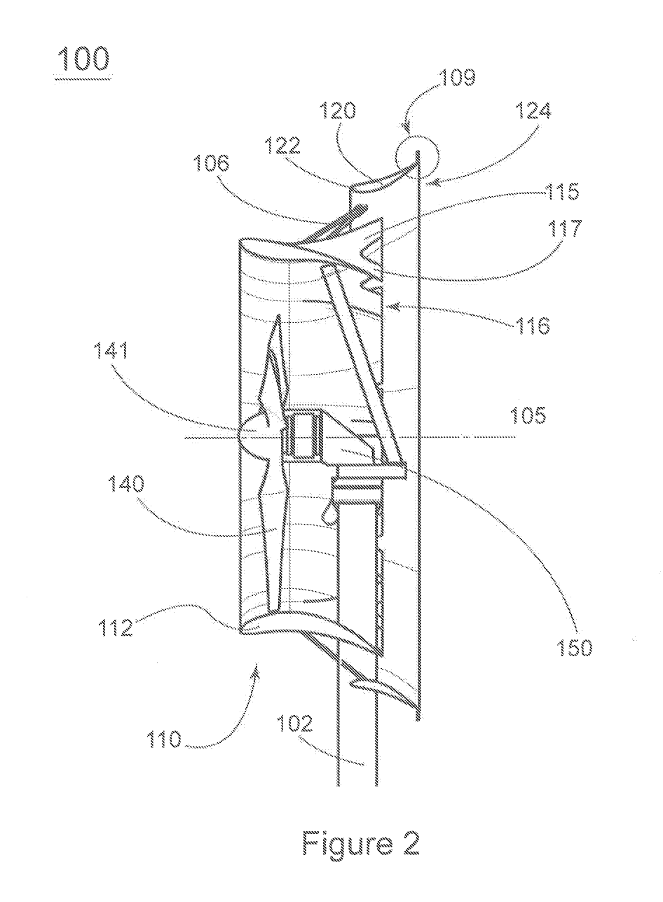

FIGS. 1 and 2 depict is a perspective view of an exemplary embodiment of a shrouded fluid turbine, in accordance with some embodiments. The shrouded fluid turbine 100 is supported by a support structure 102 and includes a turbine shroud 110, a nacelle body 150, a rotor 140, and an ejector shroud 120. The rotor 140 surrounds the nacelle body 150 and includes a central hub 141 at the proximal end of the rotor blades. The central hub 141 is rotationally engaged with the nacelle body 150. The rotor 140, turbine shroud 110, and ejector shroud 120 are coaxial with each other (i.e., they share a common central axis 105).

Although turbine shroud 110 is shown encircling the rotor 140, in some example embodiments the turbine shroud may only partially encircle the rotor (e.g., the turbine shroud may have gaps, or the rotor may extend beyond the leading edge or trailing edge of the turbine shroud). In some embodiments, the turbine shroud 110 may not encircle the rotor 140 (e.g., the rotor may be positioned in front of the leading edge or past the trailing edge of the turbine shroud).

The turbine shroud 110 includes a front end 112, also known as an inlet end or a leading edge. The turbine shroud 110 also includes a rear end 116, also known as an exhaust end or trailing edge. The trailing edge includes high energy lobes 117 and low energy lobes 115. Support members 106 are shown connecting the turbine shroud 110 to the ejector shroud 120.

The ejector shroud 120 includes a front end, inlet end or leading edge 122, and a rear end exhaust end or trailing edge 124. The ejector 120 includes a ringed foil, or in other words, is approximately cylindrical and has a foil cross-sectional shape. In some embodiments, a trailing portion of the ejector 120 includes a modified profile (e.g., a bluff protrusion 109 on a pressure surface of the foil) in a trailing portion of the foil for increased fluid turning.

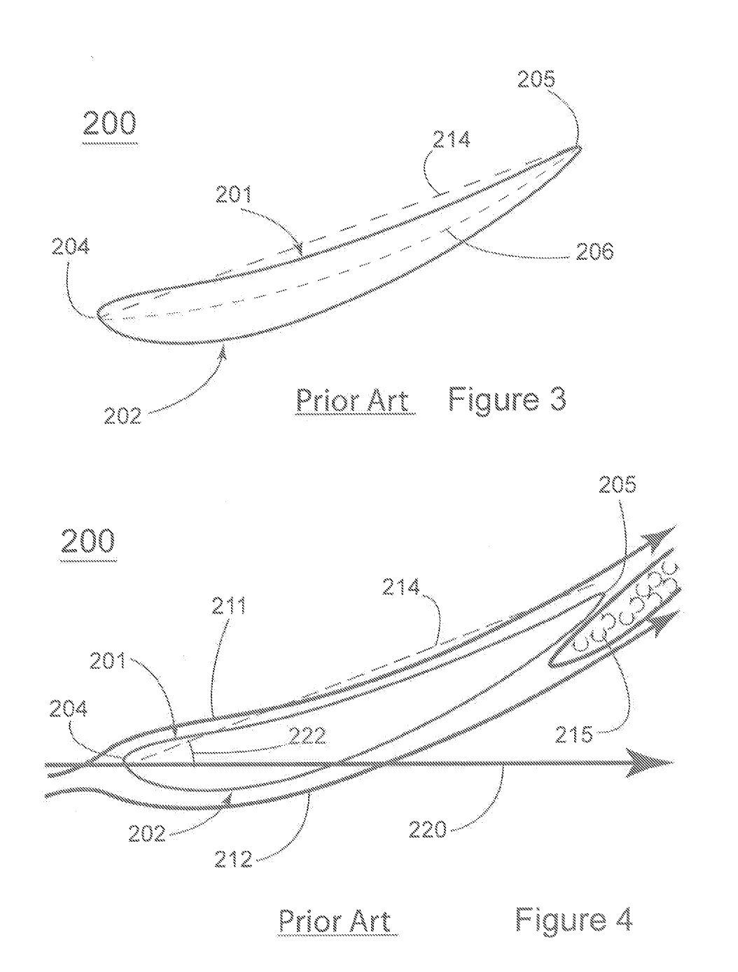

Before further description of embodiments of foils having modified profiles in accordance with various embodiments, conventional ring foils without modified profiles are depicted and described for comparison. FIG. 3 depicts a side cross-section of an upper portion of a conventional ring foil 200. The foil 200 has a suction surface (also referred to as a suction side) 202 and a pressure surface (also referred to as a pressure side) 201. The foil 200 also has a leading edge 204 and a trailing edge 205. A straight chord line 214 connects the leading edge 204 to the trailing edge 205. The leading edge of the foil 204 and the trailing edge 205 of the foil are the first and last portions of the airfoil, respectively, to be influenced by the fluid-flow. Points plotted half way between the pressure surface 201 and suction surface 202, as measured perpendicular to the chord line 214, form a mean camber line, which also may be referred to as a median camber line or a camber line, 206. The mean camber line 206 illustrates the asymmetrical form of the foil 200.

FIG. 4 illustrates the flow field around the conventional ring foil 200 of FIG. 3. The direction and path of fluid flow around the foil 200 from the leading edge 204 to the trailing edge 205 along the suction surface 202 is represented by arrow 212. The direction and path of fluid flow around the foil along the pressure surface 201 is represented by represented by arrow 211. An angle 222 between the chord line 214 of the foil and the direction of the ambient fluid flow, as depicted by arrow 220, is the angle of attack for the foil. As shown, the ring foil 200 has a high angle of attack 222. The pressure-side fluid stream 211 interacts with the suction-side fluid stream 212 at the trailing edge 205. As shown, at high angles of attack, the suction-side fluid stream 212 may separate from the suction surface 202 before the trailing edge 205. Flow separation is represented by area 215 near the trailing edge 205. The separation, or main flow leaving the surface, is a result of rising pressure and its effect on the boundary layer flow as the surface turns away from the flow direction 220. The separation causes the foil 400 to be ineffective at generating circulation as described by the Kutta-Joukowski theorem, which employs the Kutta condition that requires that the rear stagnation point is exactly on the trailing edge. In boundary separation, the rear stagnation point is moved upstream from the trailing edge to the suction surface 202 (e.g., stagnation region 215). When the main flow separates, or leaves the surface, it reduces flow turning downstream of the foil and reduces circulation.

Because the suction surface 202 turns away from the oncoming fluid stream 220, increasing the angle of attack 222 to increase flow turning downstream of the foil tends to lead to boundary flow separation on the suction surface 202 due to the suction-side fluid stream 212 being pulled away from the suction surface 202 by the by the oncoming fluid stream 220. In contrast, higher angles of attack 222 tend not to cause boundary flow separation for the pressure-side lows 211 because the pressure surface 201 turns into the oncoming fluid stream 220, which pushes the pressure-side flow 211 back toward the pressure surface 201.

FIGS. 5 and 6 schematically depict a side cross-sectional view of an upper portion of a ring foil 300 that includes a bluff protrusion 316 of a pressure surface 301 projecting outwardly from the pressure surface 301 and away from a central longitudinal axis (see central longitudinal axis 105 of FIGS. 1 and 2) of the ring foil in a trailing portion 305 of the foil, in accordance with some embodiments. In some embodiments, the ring foil 300 may be an ejector shroud of a MET (e.g., ejector shroud 120 of MET 100 in FIG. 1). In some embodiments, the ring foil 300 may be included in a single shroud fluid turbine. In some embodiments, the ring foil 300 may be included in a shrouded fluid turbine having more than two shrouds.

As shown, a suction surface 302 and a portion of the pressure surface 301 before the protrusion can be used to define a chord line 314 and a mean camber line 303 for the non-protrusion portion of the foil 300. The mean camber line 303 illustrates the asymmetrical form of the foil. The bluff protrusion 316 has a longitudinal axis 332 extending away from the chord line 314. In some embodiments, an angle 334 between the protrusion axis 332 and the chord line 314 is perpendicular or near perpendicular. For example, in some embodiments, the angle 334 is between 85° and 120°. In some embodiments, a height of the bluff protrusion hₚ is between 0.5% and 30% of a length of the chord L_{c}. In some embodiments, a height of the bluff protrusion hₚ is between 1% and 10% of a length of the chord L_{c}.

FIG. 6 schematically depicts fluid flow around the foil 300 of FIG. 5. The direction and path of fluid flow around the foil from the leading edge 304 to the trailing edge 305 along the suction surface 302 is represented by arrow 312. The direction and path of fluid flow around the foil 300, from the leading edge 304 to the trailing edge 305 along the pressure surface 301 is represented by arrow 311.

As illustrated, the bluff protrusion 316 creates an area of stagnation 315 on the pressure surface 301 upstream of the bluff protrusion 316. The addition of the bluff protrusion 316 at the trailing portion 305 of the foil also generates a pair of counter-rotating vortices 318a, 318b downwind of the trailing portion 305, specifically aft of and proximal to the protrusion 316, that affect the fluid flows 311, 312 from the pressure surface 301 and from the suction surface 302 downstream of the foil. The counter-rotating vortices 318a, 318b create a low pressure region 319 that pulls/deflects the flow from the suction surface 312d away from the central axis increasing the fluid turning downstream of the foil. The low pressure region 319 also slightly deflects the flow from the pressure surface 311d toward the central axis. The low pressure region 319 from the counter-rotating vortices 318a, 318b downstream of the protrusion 316. By pulling the suction-side fluid stream 312d downstream of the foil away from the central axis, the low pressure region 319 keeps the suction-side fluid stream 312 attached to the suction surface to generate improved circulation.

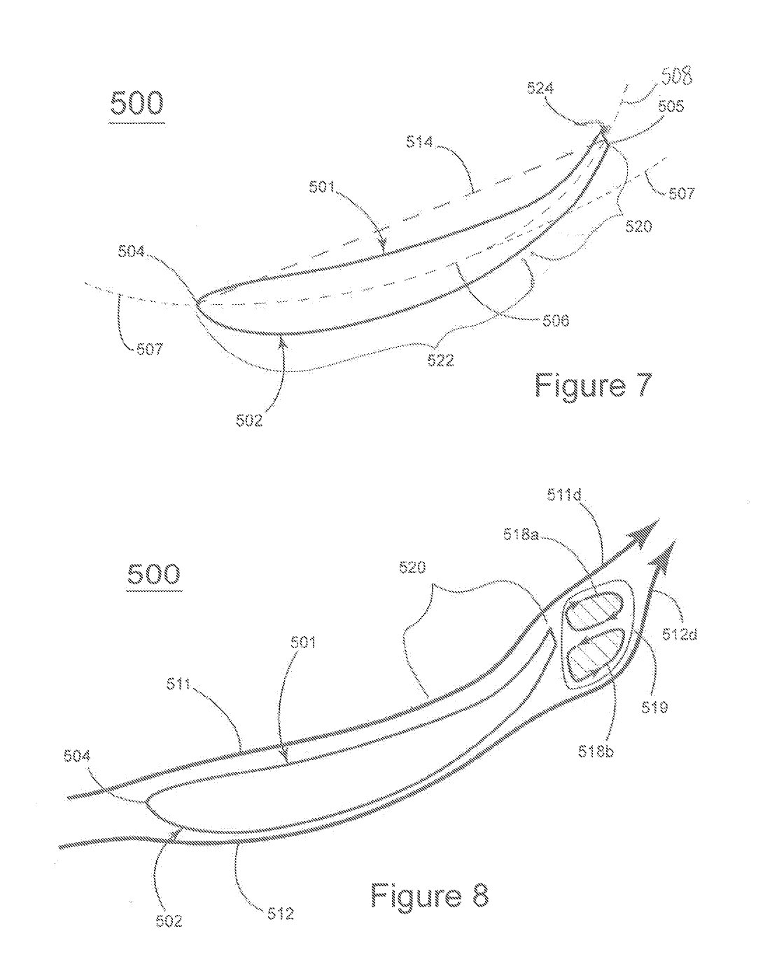

In embodiments having a protrusion on a pressure surface, the abrupt transition in a shape of the pressure surface at the upstream surface of the protrusion may significantly increase the drag on the foil. In some embodiments, a trailing portion of a foil is aerodynamically modified to increase fluid turning without an abrupt transition in a shape of the pressure surface, thus providing the increased circulation without increased drag or with less increase in drag. For example, FIGS. 7 and 8 depict another embodiment of a ring foil 500. Ring foil 500 may be employed in a shrouded fluid turbine having a single shroud and/or may be employed in a shrouded fluid turbine having multiple shrouds (e.g., in a MET). The ring foil 500 includes a suction surface 502, a pressure surface 501, a leading edge 504, and a trailing portion 520 including a trailing edge 505. A chord line 514 and a mean camber line 506 extend from the leading edge 504 to the trailing edge 505.

In the trailing portion 520 of the foil, the mean camber line 506 has a greater curvature (i.e., a smaller radius of curvature) than in a leading portion 522 of the foil. In FIG. 7, the curvature of the camber line 506 in the leading portion 522 of the foil is illustrated with arc 507 and the curvature of the camber line 506 in the trailing portion 520 of the foil is illustrated with arc 508. In some embodiments, the curvature of the mean camber line in the trailing portion may be between 1.5 times and 2.5 times the curvature of the mean camber line in the leading portion. Further, the pressure surface 502 and the suction surface 504 may meet in a blunt end surface 524 as shown.

In FIG. 8, the direction and path of fluid flow around the foil 500 on the suction side is represented by arrow 512. The direction and path of fluid flow around the foil 500 on the pressure side is represented by arrow 511. The increased curvature of the mean camber line 506 in the trailing portion 520 and the blunt end surface 524 form a bluff trailing portion of the foil that creates a pair of counter-rotating vortices 518a, 518b downstream of and proximal to the trailing portion 520. The counter-rotating vortices 518a, 518b create a low pressure region 519 that draws the suction-side flow 512d away from the central axis downstream of the foil without flow separation or with reduced flow separation. The shape of the foil 500 provides improved circulation of the fluid-flow (i.e., increased fluid turning) from both sides of the foil 511d, 512d as compared with the conventional foil of FIGS. 2 and 3. The modified profile of the trailing portion 520 of the foil emulates the fluid-streams 311/312 generated by the pressure surface protrusion 316 without creating the area of stagnation 315 (see FIGS. 4 and 5), thereby providing improved circulation with lower drag. The foil 500 of FIGS. 7 and 8 is also more effective at turning the fluid flow on the pressure side than the bluff protrusion, resulting in increased circulation and increased lift.

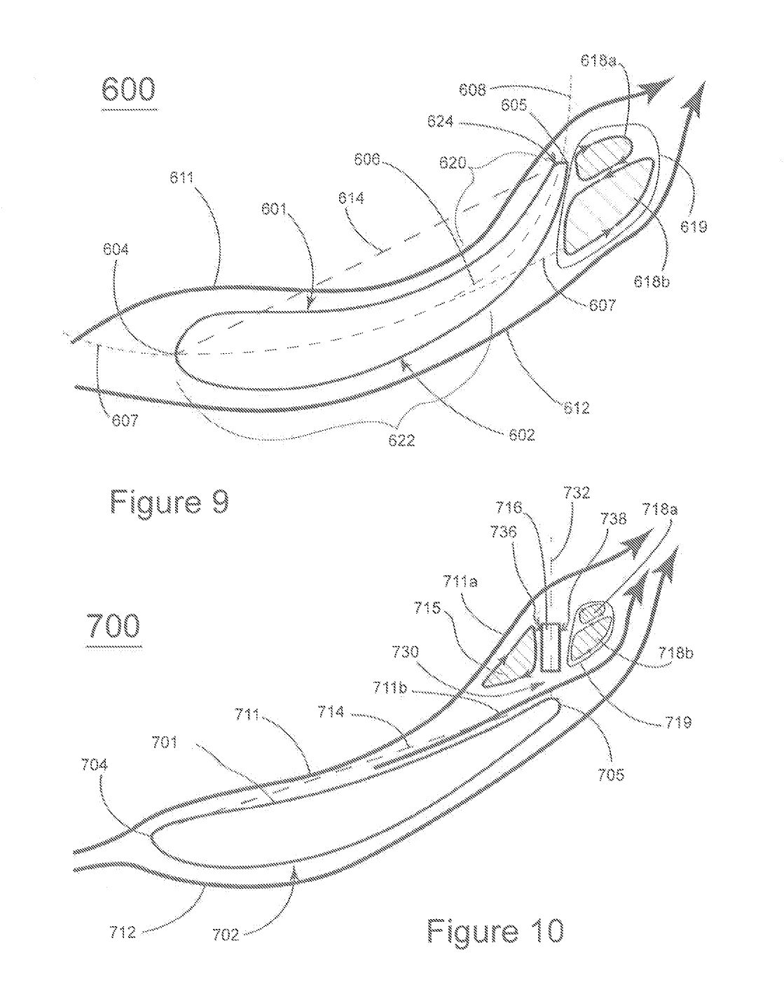

FIG. 9 depicts another embodiment of a ring foil 600 having a modified trailing portion 620, in accordance with some embodiments. Ring foil 600 may be employed in a shrouded fluid turbine having a single shroud and/or may be employed in a shrouded fluid turbine having multiple shrouds (e.g., in a MET). The ring foil 600 includes a suction surface 602, a pressure surface 601, a leading edge 604, and the trailing portion 620 including a trailing edge 605. A chord line 614 and a mean camber line 606 extend from the leading edge 604 to the trailing edge 605.

In the trailing portion 620 of the foil, the mean camber line 606 has a larger curvature (i.e., a smaller radius of curvature) than in a leading portion 622 of the foil. In FIG. 9, the curvature of the camber line 606 in the leading portion 622 of the foil is illustrated with arc 607 and the curvature of the camber line 606 in the trailing portion 620 of the foil is illustrated with arc 608. The pressure surface 602 and the suction surface 604 may meet in a blunt end surface 624 as shown. The direction and path of fluid flow around the foil 600 on the suction side 602 is represented by arrow 612. The direction and path of fluid flow around the foil 600 on the pressure side 601 is represented arrow 611.

The increased curvature of the mean camber line 606 in the trailing portion 620 and the blunt end surface 624 form a bluff trailing portion of the foil that creates a pair of counter-rotating vortices 618a, 618b downstream of and proximal to the trailing portion 620. The counter-rotating vortices 618a, 618b create a low pressure region that draws the suction-side flow 612d away from the central axis downstream of the foil without flow separation or with reduced flow separation. The shape of the foil 600 provides improved circulation of the fluid-flow (i.e., increased fluid turning) from both sides of the foil 611d, 612d as compared with the conventional foil of FIGS. 2 and 3. As compared with ring foil 500 of FIGS. 7 and 8, the trailing portion 620 of ring foil 600 of FIG. 9 turns further away from the wind to achieve greater amounts of flow turning.

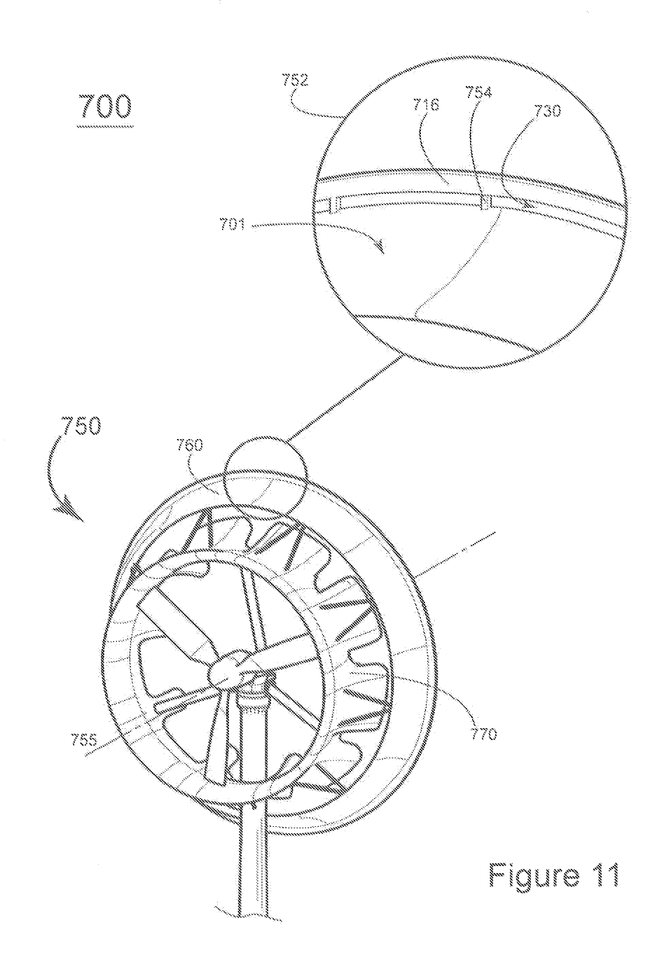

FIG. 10 schematically depicts a ring foil 700 with a pressure surface 701 having bluff protrusion 716 extending outwardly from the pressure surface 701 and away from the central longitudinal axis (see central longitudinal axis 755 of FIG. 11) of the ring foil, in accordance with some embodiments. Ring foil 700 may be employed in a shrouded fluid turbine having a single shroud and/or may be employed in a shrouded fluid turbine having multiple shrouds (e.g., in a MET). As shown, a suction surface 702 and a portion of the pressure surface 701 upstream of the protrusion can be used to define a chord line 714 for the non-protrusion portion of the foil 700. The bluff protrusion 716 has a longitudinal axis 732 extending away from the chord line 714. As illustrated, protrusion 716 defines one or more channels 730 from a leading surface 736 of the bluff protrusion to a trailing surface 738 of the bluff protrusion.

The direction and path of fluid flow around the foil from the leading edge 704 past a trailing edge 705 along the suction surface 702 is represented by arrow 712. Fluid flow 711 along the pressure surface 701 splits into a first portion 711a that flows over the protrusion and a second portion, also referred to as a bypass portion, 711b that flows through the channel 730. The proportion of the pressure-side fluid flow 711 that passes through the channel 730 may be determined, at least in part, by the orientation and position of the protrusion 716 relative to the foil and the orientation and position of the channel 730.

As illustrated, the bluff protrusion 316 creates an area of stagnation 715 on the pressure surface 701 of the foil. The bluff protrusion 316 at the trailing portion 305 of the foil also generates a pair of counter-rotating vortices 718a, 718b aft of and proximal to the protrusion 316 that affect the pressure-side fluid flows 711a, 711b and the suction side fluid flow 712. Specifically, counter-rotating vortices 718a, 718b create a low pressure region 719 that pulls/deflects the flow from the suction surface 712 away from the central axis increasing the fluid turning downstream of the foil. The low pressure region 719 also deflects the second portion 711b of the pressure-side flow away from the central axis. The low pressure region slightly deflects the first pressure-side flow 711a toward the central axis. By pulling the suction-side fluid stream 712 away from the central axis downstream of the foil, the foil generates greater fluid turning while keeping the suction-side fluid stream 712 attached to the suction surface 702 to generate improved circulation. The bypass of at least a portion of the pressure side fluid flow 711 through the channel 730 serves to reduce drag on the foil 700 and can further improve flow turning of the suction side and pressure side airflows (712 and 711a, 711b respectively).

FIG. 11 schematically depicts a mixer-ejector wind turbine 750, in which the ejector shroud 760 has the structure of the ring foil 700 of FIG. 10 including the protrusion 716 on the pressure surface 701 that defines channels 730, in accordance with some embodiments. As shown in the detail 752, channels 730 defined by the protrusion 716 are in the form of slots that at least partially separate the protrusion 716 from the rest of the pressure surface 701. The protrusion 716 and the non-protrusion portion of the airfoil 700 may be connected by support members 754. Although FIG. 11 includes an ejector shroud 760 with a modified trailing portion, in some embodiments, a mixer shroud 770 may have a modified trailing portion, and/or both the ejector shroud 760 and the mixer shroud 770 may have a modified trailing portion.

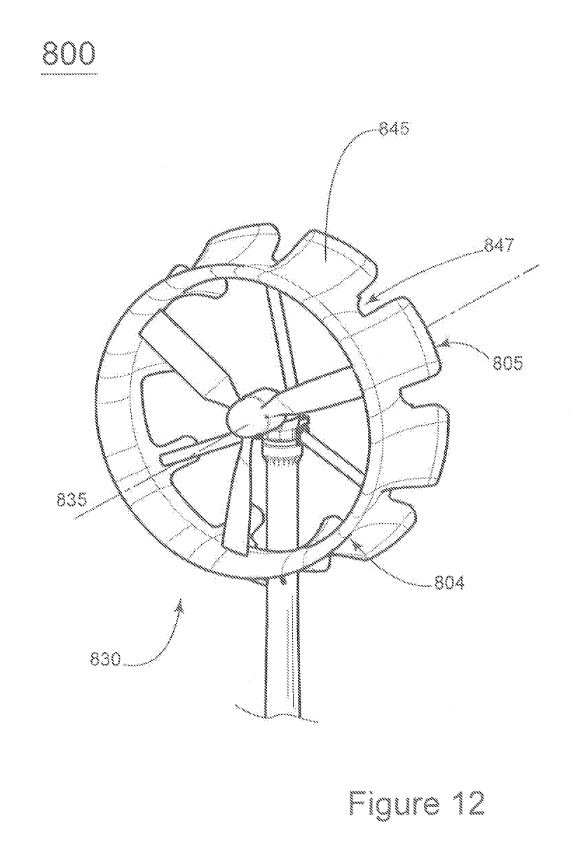

FIGS. 12 and 13 schematically depict a single mixer shroud wind turbine 800 in which outward mixing lobes 845 of a mixer shroud 830 are modified to achieve increased fluid turning. The shrouded wind turbine has a central longitudinal axis 835. The mixer shroud 830 includes inward mixing lobes 847 that turn inward toward a central axis 835 of the fluid turbine and the outward mixing lobes 847 that turn away from the central axis 835. As shown in detail 843, outward mixing lobes 845 have a foil shape with a pressure surface 801 and a suction surface 802 that meet in a trailing portion 820 at a blunt surface 824. The foil has a chord 814 and a mean camber line 806 extending between a leading edge 804 and a trailing edge 805. A profile of the foil is modified such that the mean camber line 806 has a larger curvature in the trailing portion 820 than in a leading portion 822 of the foil. Arc 807 illustrates the curvature of the leading portion 822 and arc 808 illustrates the curvature of the trailing portion 820. In use, the blunt surface 824 and the increased camber curvature in the trailing portion 820 create a pair of counter-rotating vortices that increase fluid turning by the outward mixing lobes 845. For comparison, detail 842 includes a guide 849 that indicates a profile of an unmodified outward mixing lobe having a constant curvature of the mean camber line. As shown in detail 842, the inward mixing lobe 847 has a sharp trailing edge 805′ and a mean camber line 806′ having a curvature that does not significantly increase in a trailing edge portion 820′. As used herein, a sharp trailing edge is a trailing edge where a pressure surface and a suction surface meet and are not separated by an additional surface at the trailing edge.

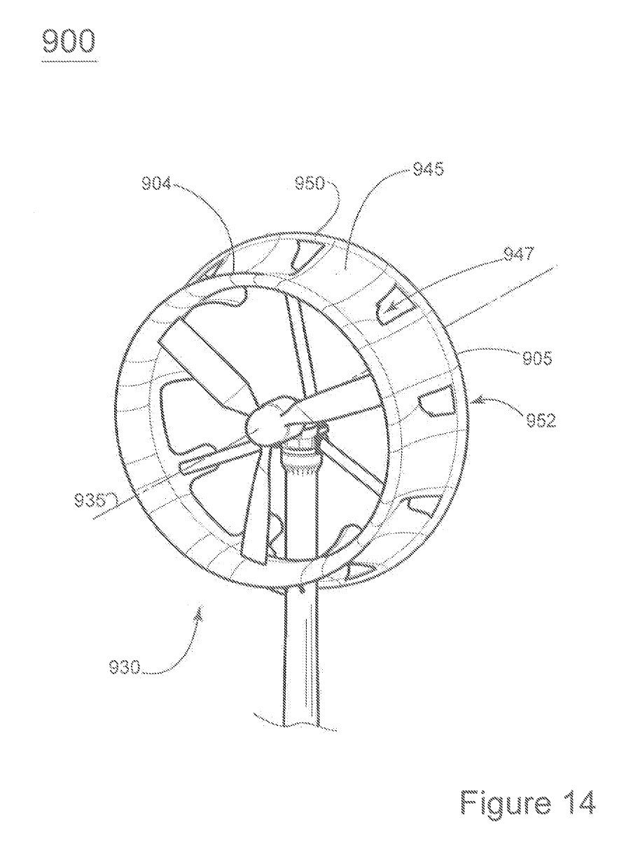

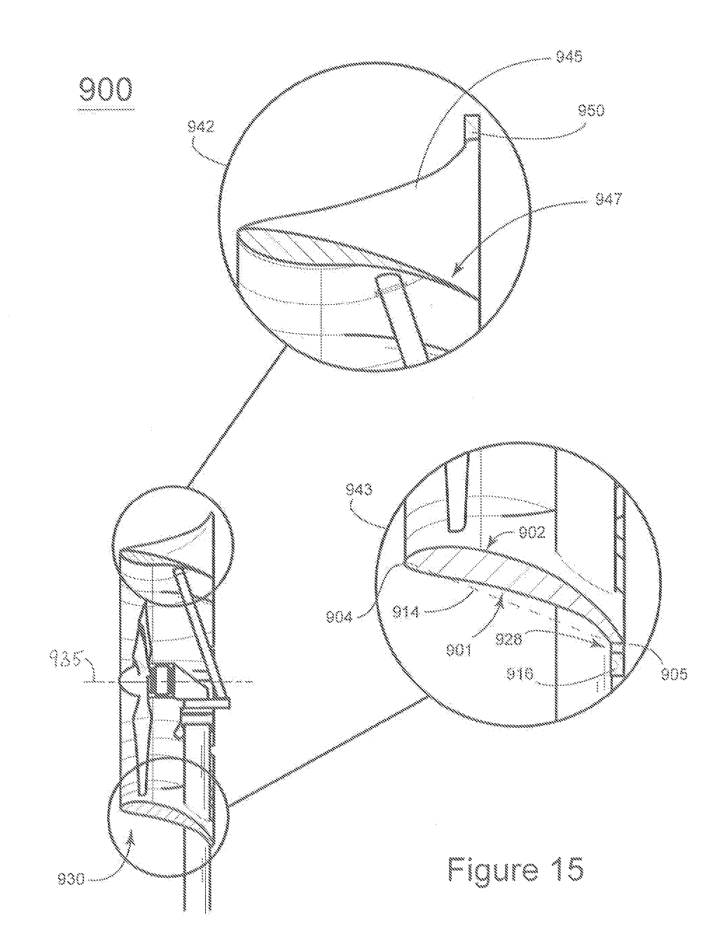

FIGS. 14 and 15 schematically depict a single shroud mixer fluid turbine 900 with a central longitudinal axis 935 and a mixer shroud 930 including outward mixing lobes 945, each having a side cross-sectional foil profile that includes a protrusion 916 on a pressure surface 901. As shown in detail 943 of FIG. 15, a suction surface 902 and the pressure surface 901 define a chord 914 of a non-protrusion portion of the foil. The protrusion 916 of the pressure surface 901 extends away from the chord 914. As shown, the protrusion 916 may define a channel 928 that enables bypass flow along the pressure surface 901. As shown in FIG. 14 and detail 942 of FIG. 15, the protrusions 916 of the outward mixing lobes 945 may be connected by spanning portions 950 over the inward mixing lobes 947 to form a ring 952. In some embodiments, the protrusions may not be connected by spanning portions over the inward mixing lobes.

Those skilled in the art in view of the present disclosure will readily appreciate that many modifications are possible in the example embodiments without materially departing from this disclosure. Accordingly, all such modifications are intended to be included within the scope of this disclosure as defined in the following claims.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. An aerodynamically contoured ring fluid foil for use in an energy extraction fluid turbine comprising;
a suction surface facing toward a central longitudinal axis of the ring fluid foil;
a pressure surface opposite the suction surface; and
a bluff protrusion at a trailing portion of the ring fluid foil, the bluff protrusion extending outwardly from the pressure surface and away from a chord of a non-protrusion portion of the ring fluid foil.

2. The aerodynamically contoured ring fluid foil of claim 1, wherein a side cross-section of the ring fluid foil has a longitudinal axis of the bluff protrusion oriented at an angle of between 85 degrees and 120 degrees with respect to the chord of the non-protrusion portion of the ring fluid foil.

3. The aerodynamically contoured ring fluid foil of claim 2, wherein a side cross-section of the ring fluid foil has a longitudinal axis of the bluff protrusion oriented about perpendicular to the chord of the non-protrusion portion of the ring fluid foil.

4. The aerodynamically contoured ring fluid foil of claim 1, wherein a height of the bluff protrusion is between 0.5% and 30% of a length of the chord.

5. The aerodynamically contoured ring fluid foil of claim 4, wherein the height of the bluff protrusion is between 1% and 10% of the length of the chord.

6. The aerodynamically contoured ring fluid foil of claim 1, wherein the bluff protrusion has a shape configured to generate a counter-rotating pair of fluid vortices downstream of and proximal to the bluff protrusion.

7. The aerodynamically contoured ring fluid foil of claim 6, wherein the counter-rotating pair of fluid vortices generated downstream of and proximal to the bluff protrusion deflect a flow stream from the suction surface away from the central axis.

8. The aerodynamically contoured ring fluid foil of claim 7, wherein the counter-rotating pair of fluid vortices are generated downstream of and proximal to the bluff protrusion without boundary layer flow separation on the suction surface.

9. The aerodynamically contoured ring fluid foil of claim 1, wherein the bluff protrusion defines channels extending from a leading surface of the bluff protrusion to a trailing surface of the bluff protrusion.

10. The aerodynamically contoured ring fluid foil of claim 9, wherein the channels comprise slots at least partially separating the bluff protrusion and the non-protrusion portion of the ring fluid foil.

11. An energy extraction fluid turbine comprising:
a rotor configured to rotate about a central longitudinal axis; and
a ring fluid foil having a trailing edge downstream of the rotor, the ring fluid foil including:
a suction surface facing toward the central axis;
a pressure surface opposite the suction surface; and
a bluff protrusion at a trailing portion of the ring fluid foil, the bluff protrusion extending outwardly from the pressure surface and away from a chord of a non-protrusion portion of the ring fluid foil.

12. The energy extraction fluid turbine of claim 11, wherein a side cross-section of the ring fluid foil has a longitudinal axis of the bluff protrusion oriented at an angle of between 85 degrees and 120 degrees with respect to the chord of the non-protrusion portion of the ring fluid foil.

13. The energy extraction fluid turbine of claim 11, wherein a height of the bluff protrusion is between 0.5% and 30% of a length of the chord.

14. The energy extraction fluid turbine of claim 13, wherein the height of the bluff protrusion is between 1% and 10% of the length of the chord.

15. The energy extraction fluid turbine of claim 11, wherein the bluff protrusion has a shape configured to generate a counter-rotating pair of fluid vortices downstream of and proximal to the bluff protrusion.

16. The energy extraction fluid turbine of claim 15, wherein the counter-rotating pair of fluid vortices generated downstream of and proximal to the bluff protrusion deflect a flow stream from the suction surface away from the central axis.

17. The energy extraction fluid turbine of claim 16, wherein the counter-rotating pair of fluid vortices are generated downstream of and proximal to the bluff protrusion without boundary layer flow separation on the suction surface.

18. The energy extraction fluid turbine of claim 11, wherein the bluff protrusion defines channels extending from a leading surface of the protrusion to a trailing surface of the protrusion.

19. The energy extraction fluid turbine of claim 18, wherein the channels comprise slots at least partially separating the bluff protrusion and the non-protrusion portion of the ring fluid foil.

20. The energy extraction fluid turbine of claim 11, wherein the ring fluid foil is an ejector shroud and wherein the fluid turbine further comprises a mixer shroud upstream of the ejector shroud.

21. The energy extraction fluid turbine of claim 11, wherein the ring fluid foil is a mixer shroud and wherein the fluid turbine further comprises an ejector shroud downstream of the mixer shroud.

22. An aerodynamically contoured ring fluid foil for use in an energy extraction fluid turbine comprising;
a suction surface facing toward a central axis of the ring fluid foil; and
a pressure surface opposite the suction surface, the pressure surface and the suction surface joined by a blunt surface at a trailing portion of the ring fluid foil, the ring fluid foil having a cross-sectional profile with a mean camber line having a greater curvature in the trailing portion than in a leading portion of the ring fluid foil.

23. The ring fluid foil of claim 22, wherein the blunt surface and the profile are configured to create counter-rotating vortices downstream of and proximal to the trailing portion that deflect a flow stream from the suction surface away from the central axis.

24. The ring fluid foil of claim 23, wherein the flow stream from the suction surface is deflected away from the central axis without boundary layer separation on the suction surface.

25. The ring fluid foil of claim 22, wherein the curvature of mean camber line in the trailing portion is between 1.5 times and 2.5 times the curvature of the mean camber line in the leading portion.

26. An energy extraction fluid turbine comprising:
a rotor configured to rotate about a central axis; and
a ring fluid foil having a trailing edge downstream of the rotor, the ring fluid foil including:
a suction surface facing toward the central axis; and
a pressure surface opposite the suction surface, the pressure surface and the suction surface joined by a blunt surface at a trailing portion of the ring fluid foil, the ring fluid foil having a cross-sectional profile with a mean camber line having a greater curvature in the trailing portion than in a leading portion of the ring fluid foil.

27. The fluid turbine of claim 26, wherein the blunt surface and the profile are configured to create counter-rotating vortices downstream of and proximal to the trailing portion that deflect a flow stream from the suction surface away from the central axis.

28. The fluid turbine of claim 26, wherein the curvature of mean camber line in the trailing portion is between 1.5 times and 2.5 times the curvature of the mean camber line in the leading portion.

29. The fluid turbine of claim 26, wherein the ring fluid foil is an ejector shroud and wherein the fluid turbine further comprises a mixer shroud upstream of the ejector shroud.

30. The fluid turbine of claim 26, wherein the ring fluid foil is a mixer shroud and wherein the fluid turbine further comprises an ejector shroud downstream of the mixer shroud.
